(19) United States
(12) Patent Application Publication
(10) Pub. No.: US 2021/0394397 A1
(43) Pub. Date: Dec. 23, 2021

(54) METHOD AND APPARATUS FOR FORMING A MATERIAL BATCH FOR AN END PRODUCT

(71) Applicant: Kompopat Oy, Konnunsuo (FI)

(72) Inventors: Juha VARIS, Lappeenranta (FI); Veikko OLKKONEN, Lappeenranta (FI); Ville IMMONEN, Lappeenranta (FI)

(21) Appl. No.: 17/292,781

(22) PCT Filed: Nov. 12, 2019
(86) PCT No.: PCT/FI2019/050806

§ 371 Date: May 11, 2021

(30) Foreign Application Priority Data
Nov. 12, 2018 (FI) 20185960
Dec. 3, 2018 (FI) 20186040

(51) Int. Cl. B29B 9/06; B65G 1/04

(52) U.S. Cl. CPC B29B 9/06; B29K 2105/26; B65G 1/0485

(57) ABSTRACT

The disclosure includes a method and an apparatus for forming a material batch in a continuous manner to form an end product. A material batch (4) is formed from material pieces (1) of predetermined sizes on a temporary storage device (2) by leaving a gap between each of the material pieces (1), and at least two temporary storage devices (2, 108) are arranged side by side and/or one above the other in order to collect the material batch, and the material batch is collected on a temporary storage device such that a material batch is collected on each of the temporary storage devices one after the other and the next material batch is formed on a next temporary storage device when the previous material batch is ready on a previous temporary storage device.

### FIELD OF THE INVENTION

The invention relates to a method defined in claim 1 and to an apparatus defined in claim 16 for forming a material batch in a continuous manner in order to form an end product, and to the use of the method as defined in claim 28.

### BACKGROUND OF THE INVENTION

Various methods are known in the prior art for selecting and using different materials for an end product. The material or material stream is conveyed to the manufacture of the end product.

### OBJECT OF THE INVENTION

The object of the invention is to disclose a new method and apparatus for forming a material batch for the manufacture of an end product. In addition, the object of the invention is to disclose a method and an apparatus for assembling and transferring material batches in order to form an end product. In addition, the object of the invention is to disclose a method and an apparatus to improve a continuous end product manufacturing process, in which material loss may be reduced. In addition, the object of the invention is to disclose a flexible manufacturing process for manufacturing various end products.

### SUMMARY OF THE INVENTION

The method, apparatus and use according to the invention are characterized by the features presented in the claims.

### DETAILED DESCRIPTION OF THE INVENTION

In a method according to the invention for forming a material batch in a continuous manner for an end product, a material batch that may contain one or more than one material piece is formed from material pieces of predetermined sizes on a temporary storage device, e.g. a temporary storage platform, by leaving a gap between each of the material pieces, and at least two temporary storage devices are arranged side by side and/or one above the other in order to collect the material batch, and the material batch is collected on a temporary storage device, preferably each of the temporary storage devices, such that a material batch is collected on each of the temporary storage devices one after the other and the next material batch is formed on a next temporary storage device when the previous material batch is ready on a previous temporary storage device. Preferably, the material batch is formed into an end product by a suitable further treatment.

In addition, the invention is based on an apparatus for forming a material batch in a continuous manner for an end product, which apparatus comprises temporary storage devices on which a material batch that may contain one or more than one material piece is formed from material pieces of predetermined sizes by leaving a gap between each of the material pieces, and the apparatus comprises at least two temporary storage devices, arranged side by side and/or one above the other, for collecting the material batch, wherein the material batch is collected on a temporary storage device such that a material batch is collected on each of the temporary storage devices one after the other and the next material batch is formed on a next temporary storage device when the previous material batch is ready on a previous temporary storage device. Preferably, a material batch may be collected on each of the temporary storage devices.

In this connection, the material batch refers to any material batch, material portion or the like, which has been formed from material pieces and which comprises one or more than one material piece, preferably more than one material piece. The material pieces in the material batch may be of different sizes and shapes, but their size and shape has preferably been predetermined, preferably depending on the end product which is to be manufactured from the material batch. The size of the material piece may vary, e.g. from grain-size to a large piece. The material piece may be in the form of a granular piece, grains, agglomerate, aggregate, solid piece, rigid piece, stiff piece, stiff paste, plastic paste, or elastic paste, or in the form of a material coalition, or in the form of their combination. The material piece may consist of one distinct piece, e.g. a solid piece, stiff piece or stiff paste, or of a material pile or a material coalition, e.g. a pile formed by granular components or the like or a piece or portion formed from a paste. Preferably, in the material batch the material pieces are positioned on the temporary storage device in a suitable arrangement in view of the end product.

In one embodiment, the apparatus comprises at least two temporary storage devices arranged side by side. In one embodiment, the apparatus comprises at least two temporary storage devices arranged one above the other. Alternatively, the temporary storage devices have been arranged in some other manner in relation to each other. In one embodiment, the temporary storage devices are laterally and/or vertically movable.

A material batch is collected on each of the temporary storage devices one after the other and the next material batch is formed on a next temporary storage device when the previous material batch is ready on a previous temporary storage device, i.e. when the previous material batch has been formed into a desired material batch on the previous temporary storage device. Preferably, a new material batch may be formed on the temporary storage device when the temporary storage device is empty, i.e. the previous material batch has been transferred from the temporary storage device, e.g. to a second transfer device.

In one embodiment, the material pieces are formed in a continuous manner at least by means of heat from a desired starting material. In one embodiment, the material pieces are formed in a continuous manner by means of heat and extrusion from a desired starting material. In one embodiment, the material pieces are formed from a material formed from a starting material by cutting into suitable material pieces of desired sizes. In one embodiment, the material pieces are formed by means of a material piece forming device. In one embodiment, the material pieces are cut by means of a material piece cutting device.

In this connection, the starting material may be any starting material, which has preferably been selected on the basis of the end product. The starting material may contain one or more components. In one embodiment, the components of the starting material may have been selected from the following: fibre-based component, polymer-based component, wood-based component, textile-based component, rock material based component, or their different combinations. In one embodiment, the starting material contains at least one fibre-based component. In one embodiment, the starting material contains at least one polymer-based component. Alternatively, the starting material may comprise any suitable starting material components. In one embodiment, the starting material or at least one starting material component may be a recycled or waste material. Alternatively, the starting material or at least one starting material component may be a virgin material, refined material, or treated material.

In one embodiment, the material pieces are formed from a material profile, which is formed in a material profile forming device by means of heat. In one embodiment, the material pieces are formed from a material profile, which is formed in a material profile forming device at least by means of heat. The forming device may be any suitable device in which a starting material is formed into a desired material profile by means of heat or heat and pressure, e.g. extrusion or forcing through a die.

In one embodiment, the material pieces are formed from a material profile by cutting material pieces of desired sizes from the material profile before being transferred to the temporary storage device. In one embodiment, the material pieces are cut by means of a material piece cutting device.

In one embodiment, the material pieces or parts of the material batch are formed by dispensing a starting material by means of a dispensing device.

In one embodiment, the material pieces are formed from a granulated material. In one embodiment, the parts of the material batch, i.e. material pieces, are formed by dispensing a granulated material by means of a dispensing device, e.g. into material coalitions or piles on the temporary storage device.

In one embodiment, the material pieces are transferred from the material piece forming device, material profile forming device or material piece cutting device to the temporary storage device.

In one embodiment, the apparatus comprises at least one material piece forming device.

In one embodiment, the apparatus comprises at least one material profile forming device to form a material profile, from which the material pieces are formed, and the material profile forming device forms the material profile at least by means of heat.

In one embodiment, the apparatus comprises at least one cutting device, in which the material pieces are formed from a material profile by cutting material pieces of desired sizes from the profile, before the temporary storage device. In one embodiment, the apparatus comprises at least one cutting device, in which the material pieces are formed from a material formed from a starting material by cutting into suitable material pieces of desired sizes.

In one embodiment, the apparatus comprises a dispensing device for forming the material pieces or parts of the material batch by dispensing them from a starting material.

The material piece forming device, dispensing device, material profile forming device, or material piece cutting device may be any device suited to the purpose of use and known per se.

In one embodiment, the material piece is transferred to the temporary storage device by means of a first transfer device. The first transfer device may be any transfer device suited to the purpose of use.

In one embodiment, the apparatus comprises at least one first transfer device for transferring the material piece to the temporary storage device. In one embodiment, the first transfer device may be a transferrer device, accelerator device, or their combination. In a preferred embodiment, the purpose of the first transfer device is to arrange the material piece feed to the temporary storage device at a suitable speed. In one embodiment, the purpose of the first transfer device is to adjust the material piece feed to the movement speed of the temporary storage device, e.g. to its moving speed or the rotating speed of the belt. Preferably, by means of the first transfer device it is possible to arrange sufficient gaps between the material pieces, especially if the material pieces come from the formation of the material pieces continuously and/or at a high speed. In one embodiment, the material piece is transferred to the temporary storage device by means of the first transfer device in order to arrange material piece feed to the temporary storage device at a suitable speed in order to arrange sufficient gaps between the material pieces.

In one embodiment, the temporary storage devices are laterally and/or vertically movable. In another embodiment, the temporary storage devices are not moved, but the material piece is delivered by means of the first transfer device to the desired temporary storage device. Preferably, the material pieces are disposed at desired positions in the material batch, such as in a specific order. In one embodiment, each of the material pieces is disposed at a desired position on the temporary storage device, e.g. in a specific order and at a specific location in relation to the other pieces.

The temporary storage device may be any device suited to the purpose of use. In one embodiment, there are at least two temporary storage devices side by side and/or one above the other. In one embodiment, there are more than two temporary storage devices, for example three, four, five or more. In one embodiment, the temporary storage device has been selected from the following: platform, conveyor, belt, conveyor belt, roll, table, a corresponding device, or their combination.

In one embodiment, before the temporary storage device there is a roll conveyor device comprising conveyor rolls for assembling the material pieces and for transferring them further to the temporary storage device. In one embodiment, the roll conveyor device is a device in which the material pieces move freely on rotating rolls.

Preferably, a gap is arranged between each two material pieces in the temporary storage device. The gap between the material pieces is important in order to keep the material pieces separated from each other and to arrange a time delay for further treatment. In one embodiment, the length of the gap between the material pieces is arranged to be a distance at which separate material pieces do not meet each other in any material batch forming step and which may be detected by automatic recognition devices. In one embodiment, the length of the gap between the material pieces is arranged to be 1-200 mm, in one embodiment 1-100 mm. In one embodiment, the length of the gap between the material pieces is arranged to be 1-10000 mm.

In one embodiment, the delay time of the material piece from the material piece forming device, material profile forming device, or material piece cutting device to the temporary storage device is adjusted so as to keep the material piece heated to a desired temperature, preferably at above 100° C., for the time of forming the material batch. In one embodiment, the temperature of the material piece is to be kept at above 100° C. for the time of forming the material batch. In one embodiment, the temperature of the material piece is to be kept at above 80° C. for the time of forming the material batch.

In one embodiment, the temporary storage device is heated in order to keep the material pieces at a desired temperature for the time of forming the material batch. In one embodiment, the apparatus comprises at least one heating device for keeping the material pieces at a desired temperature or for heating them in connection with the temporary storage device.

In a preferred embodiment, an end product is formed from the material batch by a desired further treatment method. In one embodiment, the end product or part of it is formed in one step from the entire material batch. In one embodiment, the material batch is conveyed or transferred directly to a further treatment step for manufacturing the end product, wherein the end product is formed from the material batch e.g. by casting, pressing, or by means of heat and pressure.

In one embodiment, the material pieces of the material batch are rearranged after the temporary storage device into an arrangement that is suitable for manufacturing the end product, preferably into a predetermined arrangement or configuration. In one embodiment, the material batch is transferred by means of a further treatment step transfer device from the temporary storage device to be transferred to further treatment or to wait for further treatment. Preferably, the material batch is disposed in such a way that the material pieces of the material batch have been positioned in a suitable arrangement in view of the end product.

In one embodiment, for collecting and transferring material portions, preferably in a continuous manner, in order to form an end product, at least one predetermined material batch which has been formed from the material pieces is arranged from at least one temporary storage device, preferably from each of the temporary storage devices one after the other, on a collecting base of a second transfer device and the material batch is positioned at a predetermined location on the collecting base, and the material batch is transferred by means of the second transfer device to end product formation. The predetermined material batch, such as material portion, may be determined by means of any agreed and/or predetermined attribute or feature, such as dimension, dimensions, measure, measures, or the like, e.g. size, outer dimension, volume, indirect volume, length, thickness, weight, or another suitable physical quantity, or alternatively the material portion may be determined on the basis of run time, e.g. on the basis of the run time of the material forming device or the dispensing device.

In one embodiment, the apparatus comprises at least one second transfer device, by means of which at least one predetermined material batch, such as material portion, formed from the material pieces, is transferable from at least one temporary storage device to end product formation, and the second transfer device comprises a collecting base, on which the material batch is collected and on which the material batch is positioned at a predetermined location.

In this connection, the material portion refers to any material portion, which may have been formed from any suitable material. In this connection, the material portions do not refer to material portions used for the preparation of food or food products. The material portions may be of different sizes and shapes, but their size and shape has preferably been predetermined, preferably depending on the end product which is to be manufactured from the material portions. The material portions collected on the collecting base of the second transfer device may be of different sizes in relation to each other. The size, dimensions, weight, or volume of the material portion may vary, e.g. from grain-size to a large piece. The material portion may have been formed from grains, granules, agglomerate, aggregate, piece, solid piece, rigid piece, stiff piece, paste, stiff paste, plastic paste, mouldable paste or elastic paste or their combinations. The material portion may consist of one distinct piece, e.g. a solid piece, stiff piece, or stiff paste, of a paste or of more material components, e.g. grains, granules or the like.

In one embodiment, the material portions are formed from the material pieces. In one embodiment, the material portion is formed from solid material pieces. In one embodiment, the material portion is formed from a granulated material. In one embodiment, the material portion is formed from a paste, e.g. an elastic material.

In one embodiment, more than one material batch, such as material portion, are arranged on the collecting base of the second transfer device and the material batches are positioned in a predetermined order, such as arrangement, on the collecting base.

In the method and the apparatus, one or more material portions may be transferred in one go by means of the collecting base of the second transfer device to end product formation. In one embodiment, one material portion is transferred to end product formation. In one embodiment, more than one material portion are transferred to end product formation. Preferably, the material portions form the final material batch, from which the end product may be formed in one go. Preferably, the end product is formed from the material batch by a suitable further treatment. The material portions in the material batch may be of different sizes and shapes, but their size and shape has preferably been predetermined, preferably depending on the end product which is to be manufactured from the material batch. This way, more material can be arranged in the end product at positions where more material is needed in view of the end product formation, and less at positions where less material is needed in view of the end product formation.

In this connection, the starting material of the material batches and portions may be any starting material, which has preferably been selected on the basis of the end product.

In one embodiment, the material of the material batches, such as material portions, is formed from a starting material by means of a forming device. The forming device may be any suitable device for forming a desired material from a starting material, e.g. a heating device, a heat treatment device, an extrusion device, a feeding device, a dispensing device, another suitable device or their combination. In one embodiment, the apparatus comprises at least one forming device for forming the material of the material portions.

In one embodiment, the material portions are formed by dispensing material by means of a dispensing device. In one embodiment, the material portion is formed by dispensing granulated material by means of a dispensing device in a desired amount by volume or weight. In one embodiment, the material portion is formed by dispensing a paste, e.g. an elastic, plastic, and/or warm material, by means of a dispensing device in a desired amount, e.g. by volume, by weight, by length of the material paste, by length of the material profile or by a specific run time. In one embodiment, the apparatus comprises at least one dispensing device for forming the material portions by means of dispensing. In one embodiment, the forming device may also operate as the dispensing device. In one embodiment, there are more than one dispensing device.

The forming device for the material of the material batches or portions and/or the material portion dispensing device may be any device suited to the purpose of use and known per se.

In one embodiment, the material portions are arranged on the collecting base of the second transfer device by means of a dispensing device. In one embodiment, the material portions are arranged on the collecting base of the second transfer device from the forming device. In one embodiment, the material portions are transferred to the collecting base from the temporary storage device, on which the material of the material portions has been arranged in portions.

The apparatus comprises a temporary storage device for collecting the material portions or the material batch formed from the material portions, and the temporary storage device is located before the second transfer device. In one embodiment, two or more temporary storage devices may have been arranged side by side or one above the other, or alternatively the temporary storage devices may have been arranged in some other way in relation to each other. In one embodiment, the material portions are transferred to the collecting base of the second transfer device from one temporary storage device. In one embodiment, the material portions are transferred to the collecting base of the second transfer device from one temporary storage device, the collecting base is emptied and the next material portions are transferred to the collecting base from another temporary storage device. In one embodiment, the material portions are transferred to the collecting base of the second transfer device from more than one temporary storage device one after the other.

In one embodiment, the material portions are collected on the temporary storage device from the forming device and/or dispensing device. The temporary storage device may be any device suited to the purpose of use. The temporary storage device may have been arranged horizontally, vertically or at a suitable angle therebetween. In one preferred embodiment, the second transfer device follows the movement of the temporary storage device.

In one embodiment, the material batches or material portions are transferred from the temporary storage device or dispensing device to the collecting base of the second transfer device, which collecting base is located below or alternatively at the side of the dispensing device or temporary storage device. In one embodiment, the material portions are formed by means of the forming device and are transferred to the collecting base of the second transfer device, which collecting base is located below the forming device. In one embodiment, the collecting base is moved while collecting the material batch, such as material portion or portions, in order to arrange the material batch or material portions at correct positions on the collecting base. In one embodiment, the collecting base is moved below or at the side of the dispensing device, temporary storage device or forming device.

In one embodiment, the collecting base of the second transfer device is moved below or at the side of the temporary storage device while collecting the material batch in order to arrange the material pieces of the material batch at desired positions on the collecting base.

Preferably, the material batches, such as material portions, are positioned, i.e. disposed, on the collecting base of the second transfer device in a suitable arrangement for forming the end product. In this connection, the collecting base of the second transfer device may be any suitable base, e.g. a platform, a shaped base which has been provided with different types of areas for collecting the portions, a grip platform, a belt-type base, or their combination. In one embodiment, the material portions are arranged at desired positions on the collecting base, e.g. in a specific order and/or at specific positions. In one embodiment, each material portion is disposed at a predetermined position on the collecting base, e.g. in a specific order and at a specific location in relation to the other portions. In one embodiment, each material portion is arranged at portion areas formed in the collecting base, e.g. in depressions of the collecting base or in receptacles fitted on the collecting base. The collecting base may have been provided with depressions, e.g. sunken areas, cup-like depressions, slots or the like, or portion receptacles, e.g. crucibles, cylindrical receptacles or the like, for the material portions. In one embodiment, the collecting base has an anti-grip coating. In one embodiment, the collecting base is covered with a film, which forms an anti-grip coating for the collecting base. In one embodiment, said film may be part of the end product, i.e. the film is transferred with the material portions to end product formation.

In this connection, the second transfer device may be any transfer device suited to the purpose of use. In one embodiment, the apparatus comprises at least one second transfer device. In one embodiment, the second transfer device has been selected from the following devices: computer-controlled transfer device, remote-controlled transfer device, automatic transfer device, belt conveyor, robotic device, industrial robot, manipulator, or their combination. In a preferred embodiment, the purpose of the second transfer device is to arrange the transfer of the material batch, such as material portions, to end product formation in such a way that the amount of material needed for the manufacture of the end product or part of it is transferable in one go to the end product formation. In one embodiment, the second transfer device is movable. In one embodiment, the collecting base is moved while collecting the material portion or material portions in order to arrange the material portion or portions at desired positions on the collecting base, i.e. in a suitable arrangement on the collecting base. In one embodiment, the collecting base of the second transfer device is movable, e.g. rotatable, arrangeable at a specific angle or movable like a belt. In one embodiment, the collecting base of the second transfer device or part of it may be controlled and moved independently, e.g. rotated, arranged at a specific angle, or moved like a belt. In one embodiment, the collecting base may be divided into several parts. In one embodiment, the collecting base of the second transfer device has been divided into several parts, which parts may each be independently controlled and moved, e.g. rotated, arranged at a specific angle, or moved like a belt. In one embodiment, the collecting base of the second transfer device or each of its parts are independently controllable and movable, e.g. by means of a control device and/or software belonging to the apparatus. In one embodiment, the second transfer device comprises a vibrating device for vibrating the collecting base. In one embodiment, the second transfer device comprises a pushing device for pushing the material portions out from the collecting base in connection with an end product manufacturing device.

In one embodiment, the material batch, such as material portion or material portions, are transferred by means of the second transfer device to end product formation, e.g. to an end product manufacturing device. Preferably, the second transfer device operates as a raw material dispenser in the manufacture of the end product. In one embodiment, the second transfer device or at least its collecting base is directed to a correct position, i.e. positioned at a correct location, such as a predetermined location, in relation to the end product formation or in relation to the end product manufacturing device, e.g. to the rear edge of the material portion leaving area. When the second transfer device or its collecting base has been arranged at a correct location in relation to the end product manufacturing device, the material portion can be accurately and quickly transferred from the transfer device to a correct location in the end product formation, such as to the manufacturing device, by moving the second transfer device or its collecting base, e.g. by drawing them, vibrating them, by rotating the belt, or by drawing the collecting base entirely from thereunder, or by moving the material portion, e.g. by sliding, vibrating, or pushing. The end product may be formed by casting, pressing, or by means of heat and pressure, or by another suitable way. In one embodiment, the apparatus comprises at least one end product manufacturing device. The end product manufacturing device may be any manufacturing device that is known per se, e.g. a device based of casting, a device based on pressure, or a device based on heating and pressure. In one embodiment, the second transfer device or its collecting base is directable to a predetermined position in relation to the end product manufacturing device in order to transfer the material portions from the transfer device to the manufacturing device, e.g. by means of a control device and/or software belonging to the apparatus. In one embodiment, the end product or part of it is formed in one step from the material batch, such as material portions.

In one embodiment, the material batch, such as material portion, is kept heated, at above 80° C., or alternatively at above 100° C., for the time of transferring by the second transfer device and until it has been delivered to end product formation. In one embodiment, the delay time it takes to transfer the material portions from the material portion forming device and/or dispensing device to the end product formation is configured to be such that the material portion remains heated to a desired temperature, preferably at above 80° C. or alternatively at above 100° C. In one embodiment, the material portions are heated in order to keep the material portions at a desired temperature for the time of transferring the material portions. In one embodiment, the apparatus comprises at least one heating device for keeping the material portions at a desired temperature or for heating them for the time of transferring and until they have been delivered to end product formation, such as up to the end product manufacturing device. In one embodiment, the heating device has been arranged in connection with the second transfer device or the collecting base of the second transfer device.

The method and the apparatus according to the invention may be used in any end product manufacturing, or in the further treatment of a material or material profile formed from a starting material. In one embodiment, the method is used in the manufacture of bulk products, composite products, wood-based products, and plastic-based products, and their combinations.

The method and the apparatus according to the invention may be easily utilized in the manufacture of various end products. Due to the invention, it is possible to significantly improve efficiency in manufacture and reduce material loss. By the method and the apparatus according to the invention, a desired amount of material is provided at desired areas of the end product, when using a material batch consisting of more than one material piece in the manufacture of the end product. The material pieces of the material batch may be disposed at desired positions in the material batch. The material portions of the material batch may be disposed at desired positions on the collecting base of the second transfer device in connection with collecting and transferring the material, and thus the material portions can be easily arranged at desired areas of the end product. The assembly of the material batch may be carried out in a versatile way. A suitable material set may be assembled for the manufacture of the end product from material portions of different sizes.

The apparatus according to the invention may be easily and cost-efficiently mounted in connection with any material portion, material profile or end product manufacturing line. The method and the apparatus according to the invention provide a flexible manufacturing process. Many different, also continuously operated, material heating and paste forming devices may be utilized in the method and the apparatus according to the invention as part of the production process.

In addition, due to the invention it is possible to efficiently and economically utilize various materials, such as also various waste, recycled and side stream materials, as the starting material. Specifically, due to the invention it is possible to easily form end products from plastic, stiff and soft pastes, granular materials, as well as from solid pieces. Also non-homogeneous starting materials may be used for the manufacture of products, and nonhomogeneous materials may be formed into material portions for an end product. In addition, due to the invention also materials which cannot be transferred by gripping them from above or from the side may be easily and efficiently collected and transferred to the manufacture of an end product.

### LIST OF FIGURES

FIG. 1 represents one process according to the invention,

FIG. 2 represents another process according to the invention,

FIG. 3 represents another process according to the invention,

FIG. 4 represents one additional stage of a process according to the invention, and

FIG. 5 represents another additional stage of a process according to the invention.

### EXAMPLES

The invention will be described below by way of detailed examples of its embodiments with reference to the accompanying figures.

### Example 1

In this example, material batches (4) are formed in a continuous manner for an end product (6).

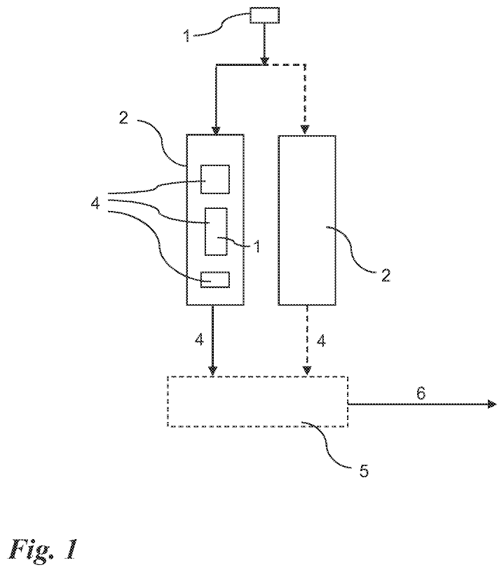

The apparatus of FIG. 1 comprises two temporary storage devices (2) arranged side by side, on which the material batch (4) is formed from material pieces (1) of predetermined sizes. The temporary storage device is herein a conveyor belt. Each material batch (4) contains more than one material piece (1). The material batch is formed by leaving a gap between each of the material pieces (1) on the temporary storage device (2). A material batch is collected on each of the temporary storage devices (2) one after the other. The material batch (4) may be conveyed or transferred, either directly of via temporary storage, to a further treatment step (5) for forming the end product (6). The material batch may be rearranged after the temporary storage device (2) into an arrangement suited for manufacturing the end product and/or the material batch may be transferred by means of a further treatment step, i.e. a second transfer device, to the further treatment step (5).

In this embodiment, the temporary storage devices (2) are laterally movable to a suitable position for collecting the material batch from the material pieces.

### Example 2

In this example, material batches (4) are formed in a continuous manner for an end product (6).

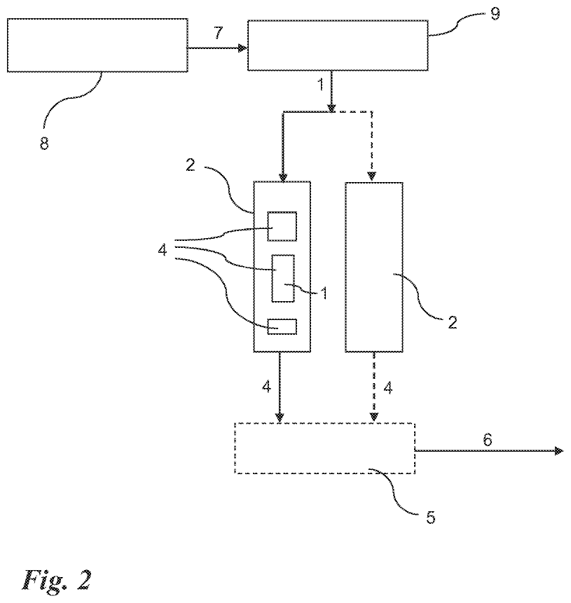

The apparatus of FIG. 2 comprises two temporary storage devices (2) arranged side by side, on which the material batch (4) is formed from material pieces (1) of predetermined sizes. The temporary storage device is herein a conveyor device.

The material pieces (1) are formed from a material profile (7), which is formed in a material profile forming device (8) at least by means of heat, and in one embodiment also pressure. The material profile (7) is cut into the material pieces (1) of desired sizes by means of a cutting device (9) before transferring the material pieces to the temporary storage device (2).

Each material batch (4) contains more than one material piece (1). The material batch is formed by leaving a gap between each of the material pieces (1) on the temporary storage device (2). A material batch is collected on each of the temporary storage devices (2) one after the other. The material batch (4) may be conveyed or transferred, either directly of via temporary storage, to a further treatment step (5) for forming the end product (6). The material batch may be rearranged after the temporary storage device (2) into an arrangement suited for manufacturing the end product and/or the material batch may be transferred by means of a further treatment step, i.e. a second transfer device, to the further treatment step (5).

### Example 3

In this example, material batches (4) are formed in a continuous manner for an end product (6).

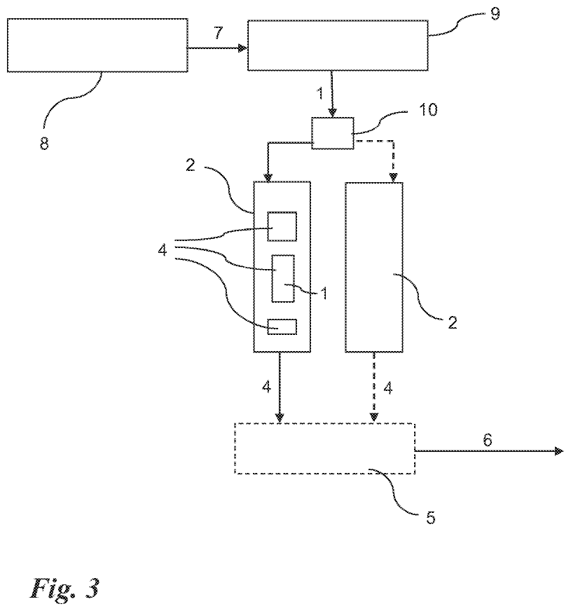

The apparatus of FIG. 3 comprises two temporary storage devices (2) arranged side by side, on which the material batch (4) is formed from material pieces (1) of predetermined sizes. The temporary storage device is herein a conveyor belt.

The material pieces (1) are formed from a material profile (7), which is formed in a material profile forming device (8) at least by means of heat, and in one embodiment also pressure. The material profile (7) is cut into the material pieces (1) of desired sizes by means of a cutting device (9) before transferring the material pieces to the temporary storage device (2).

The material pieces (1) are transferred to the temporary storage device (2) by means of a first transfer device (10). The first transfer device is in this example a transferrer, the purpose of which is to adjust the material piece feed to the movement speed of the temporary storage device, such as to the moving speed of the belt.

Each material batch (4) contains more than one material piece (1). The material batch is formed by leaving a gap between each of the material pieces (1) on the temporary storage device (2). A material batch is collected on each of the temporary storage devices (2) one after the other. The material batch (4) may be conveyed of transferred, either directly of via temporary storage, to a further treatment step (5) for forming the end product (6). The material batch may be rearranged after the temporary storage device (2) into an arrangement suited for manufacturing the end product and/or the material batch may be transferred by means of a further treatment step, i.e. a second transfer device, to the further treatment step (5).

In this embodiment, the first transfer device (10) is movable in order to deliver the material pieces (1) to the desired temporary storage device (2) by means of the transfer device. If desired, also the temporary storage devices (2) are laterally movable to a suitable position for collecting the material batch from the material pieces.

### Example 4

In this example, material batches are formed in a continuous manner for an end product.

The apparatus of this example comprises two temporary storage devices arranged side by side, on which the material batch is formed from a material piece of a predetermined size. The temporary storage device is herein a conveyor belt. Each material batch contains one material piece. The material batch is formed by arranging a gap between each of the material pieces in connection with or after the formation of the material piece in order to position the material pieces flexibly on the temporary storage devices. A material batch is collected on each of the temporary storage devices one after the other. The material batch may be conveyed or transferred, either directly of via temporary storage, to a further treatment step for forming the end product. The material batch may be transferred by means of a further treatment step, i.e. a second transfer device, to the further treatment step.

In this embodiment, the temporary storage devices are laterally movable to a suitable position for collecting the material batch.

### Example 5

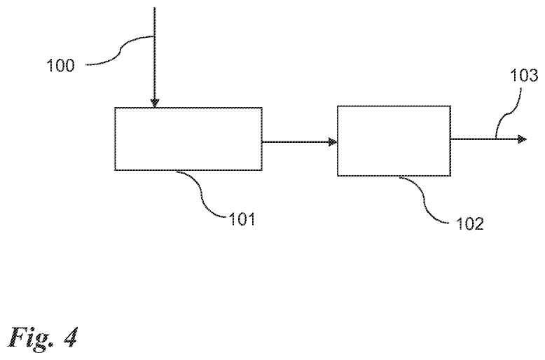

In this example, material portions are collected and transferred in a continuous manner in order to form an end product by a further process of FIG. 4.

A predetermined material portion or predetermined material portions (100), determined for example on the basis of size, dimensions, weight or volume, are transferred to a collecting base of a second transfer device (101). The material portions being collected on the collecting base may be of different sizes in relation to each other. The material portions are positioned at a predetermined location on the collecting base. Thus, they are transferable to end product formation (102) in a desired arrangement, such that a suitable material portion is arranged directly at a desired position on an end product manufacturing device and the formation of an end product (103) becomes easier and quicker. The end product (103) may be formed e.g. by casting or pressing, and/or by means of heat, if necessary.

The second transfer device (101) may be in this embodiment a computer-controlled transfer device, robot or manipulator or another suitable transfer device which comprises a collecting base for collecting the material portions. The collecting base has been selected according to the purpose of use, and it may be a platform, grip platform, belt or base which has been provided with locations for the material portions, or another base suited to the purpose of use.

The further process of FIG. 4 may be an additional stage to the processes according to Examples 1-4, preferably arranged to follow the temporary storage devices.

### Example 6

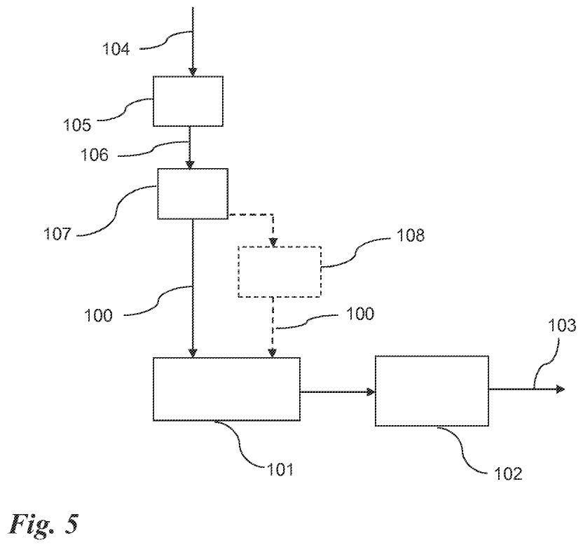

In this example, material portions are formed, collected, and transferred in a continuous manner in order to form an end product by a process of FIG. 5.

A starting material (104) is formed into a material for material portions (100) in a forming device (105). Formed material (106) may be conveyed to a dispensing device (107), from which it is dispensed as the material portions (100), e.g. granules, piece, or paste, to a collecting base of a second transfer device (101). Alternatively, the formed material (106) may be transferred directly from the forming device (105) to the collecting base of the second transfer device (101) to form the material portions on the collecting base. The collecting base may have been provided with depressions, receptacles or containers for the material portions, especially if the material portion is formed from granules or grains. Alternatively, the collecting base may be a platform, belt, or the like, on which the material portions formed e.g. from a paste or pieces can be easily collected.

The size of each of the material portions (100) arranged on the collecting base is predetermined for example on the basis of size, dimensions, weight, volume or run time, such as material feeding speed. The material portions being collected on the collecting base may be of different sizes in relation to each other. The important feature is that the material portions are positioned at a predetermined location on the collecting base. Thus, they are transferable to end product formation (102) in a desired arrangement, such that a suitable material portion can be arranged directly at a desired position on an end product manufacturing device and the formation of an end product (103) becomes easier and quicker. The end product (103) may be formed e.g. by casting or pressing, and/or by means of heat, if necessary.

The second transfer device may be in this embodiment a computer-controlled transfer device, robot or manipulator or another suitable transfer device which comprises a collecting base for collecting the material portions as described above.

The process of FIG. 5 may be an additional stage to the processes according to Examples 1-4.

### Example 7

In this example, material portions may be formed, collected and transferred in order to form an end product according to Examples 5 or 6 such that material portions (100) are transferred to a collecting base of a second transfer device (101) from a temporary storage device (108). The temporary storage device (108) may be e.g. a belt or another suitable device on which the material portions have been collected.

The second transfer device (101) is located below or alternatively at the side of the temporary storage device (108), and the material portions (100) are transferred from the temporary storage device (108) directly to the collecting base of the second transfer device (101).

The process according to this example may be an additional stage to the processes according to Examples 1-4.

The method and apparatus according to the invention are suitable as different embodiments to be used in various applications for forming a material batch and for transferring it in order to form an end product. In addition, the method and apparatus according to the invention are suitable as different embodiments to be used in the manufacture of various end products.

The invention is not limited merely to the above-presented examples, but many modifications are possible within the scope of the inventive idea defined by the claims.

1. A method for forming a material batch in a continuous manner in order to form an end product, wherein a material batch is formed from material pieces of predetermined sizes on a temporary storage device by leaving a gap between each of the material pieces, and at least two temporary storage devices are arranged side by side and/or one above the other in order to collect the material batch, and the material batch is collected on a temporary storage device such that a material batch is collected on each of the temporary storage devices one after the other and the next material batch is formed on a next temporary storage device when the previous material batch is ready on a previous temporary storage device.

2. The method according to claim 1, wherein the material pieces are formed in a continuous manner by means of heat and extrusion from a desired starting material.

3. The method according to claim 1, wherein the material pieces are formed from a material profile, which is formed in a material profile forming device by means of heat, by cutting the profile into material pieces of desired sizes before transferring them to the temporary storage device.

4. The method according to claim 1, wherein the material pieces are formed by dispensing a starting material by means of a dispensing device.

5. The method according to claim 1, wherein the material pieces are transferred from a material piece forming device, material profile forming device or material piece cutting device to the temporary storage device.

6. (canceled)

7. The method according to claim 1, wherein the material piece is transferred to the temporary storage device by means of the first transfer device in order to arrange material piece feed to the temporary storage device at a suitable speed in order to arrange sufficient gaps between the material pieces.

8. The method according to claim 1, wherein the temporary storage device has been selected from the following: platform, conveyor, belt, conveyor belt, roll, table, a corresponding device, or their combination.

9. The method according to claim 1, wherein the delay time of the material piece from the material piece forming device, material profile forming device or material piece cutting device to the temporary storage device is adjusted so as to keep the material piece at a desired temperature for the time of forming the material batch.

10. The method according to claim 1, wherein the temporary storage device is heated in order to keep the material pieces at a desired temperature for the time of forming the material batch.

11. The method according to claim 1, wherein at least one predetermined material batch which has been formed from the material pieces is arranged from at least one temporary storage device on a collecting base of a second transfer device, and the material batch is positioned at a predetermined. location on the collecting base, and the material batch is transferred by means of the second transfer device to end product formation.

12. The method according to claim 1, wherein more than one material batch are arranged on the collecting base of the second transfer device, and the material batches are positioned in a predetermined arrangement on the collecting base.

13. The method according to claim 1, wherein the collecting base of the second transfer device is moved below or at the side of the temporary storage device while collecting the material batch in order to arrange the material pieces of the material batch at desired positions on the collecting base.

14. The method according to claim 1, wherein the material batch is kept heated, at above 80° C., for the time of transferring by the second transfer device and until it has been delivered to end product formation.

15. The method according to claim 1, wherein the end product is formed from the material batch or batches in one step.

16. An apparatus for forming a material batch in a continuous manner in order to form an end product, wherein the apparatus comprises temporary storage devices on which a material batch is formed from material pieces of predetermined sizes by leaving a gap between each of the material pieces, and the apparatus comprises at least two temporary storage devices arranged side by side and/or one above the other, for collecting the material batch, wherein the material batch is collected on a temporary storage device such that a material batch is collected on each of the temporary storage devices one after the other and the next material batch is formed on a next temporary storage device when the previous material batch is ready on a previous temporary storage device.

17. The apparatus according to claim 16, wherein the apparatus comprises at least one material piece forming device.

18. The apparatus according to claim 16, wherein the apparatus comprises at least one material profile forming device to form a material profile, from which the material pieces are formed, and the material profile forming device forms the material profile at least by means of heat.

19. (canceled)

20. (canceled)

21. (canceled)

22. The apparatus according to claim 16, wherein the apparatus comprises at least one second transfer device, by means of which at least one predetermined material batch which has been formed from the material pieces is transferable from at least one temporary storage device to end product formation, and the second transfer device comprises a collecting base on which the material batch is collected and on which the material batch is positioned at a predetermined location.

23. The apparatus according to claim 16, wherein the second transfer device has been selected from the following: computer-controlled transfer device, remote-controlled transfer device, automatic transfer device, belt conveyor, robotic device, industrial robot, manipulator, or their combination.

24. The apparatus according to claim 16, wherein the collecting base of the second transfer device or part of it is independently controllable and movable.

25. (canceled)

26. The apparatus according to claim 16, wherein the second transfer device or its collecting base is directable to a predetermined position in relation to the end product manufacturing device in order to transfer the material batches from the second transfer device to the end product manufacturing device.

27. The apparatus according to claim 16, wherein the apparatus comprises at least one heating device for keeping the material batches at a desired temperature or for heating them for the time of transferring and until they have been delivered to end product formation.

28. (canceled)
